(19) United States
(12) Patent Application Publication
(10) Pub. No.: US 2026/0104048 A1
(43) Pub. Date: Apr. 16, 2026

(54) ROTARY COMPRESSOR

(71) Applicant: SAMSUNG ELECTRONICS CO., LTD., Suwon-si (KR)

(72) Inventors: Joonhyung KIM, Suwon-si (KR); Munseong KWON, Suwon-si (KR); Jaewoo PARK, Suwon-si (KR); Sedong LEE, Suwon-si (KR); Jongwon CHOI, Suwon-si (KR)

(73) Assignee: SAMSUNG ELECTRONICS CO., LTD., Suwon-si (KR)

(21) Appl. No.: 19/418,396

(22) Filed: Dec. 12, 2025

Related U.S. Application Data
(63) Continuation of application No. PCT/KR2024/005204, filed on Apr. 18, 2024.

(30) Foreign Application Priority Data
Jun. 14, 2023 (KR) 10-2023-0076347

(51) Int. Cl. F04C 29/06

(52) U.S. Cl. CPC F04C 29/065

(57) ABSTRACT

A rotary compressor includes a casing, a motor, a compression part, a plurality of refrigerant passages along an edge of the compression part, an upper muffler forming an upper muffler space allowing refrigerant to be introduced thereto through the plurality of refrigerant passages, an inner muffler forming an inner muffler space that prevents refrigerant from passing through at least one refrigerant passage and allows the refrigerant to pass through remaining refrigerant passages, an outer muffler forming an outer muffler space allowing the refrigerant from the inner muffler space prevented from passing to pass through, and a refrigerant discharge passage on a portion of the inner muffler in contact with the outer muffler space and configured such that refrigerant in the inner muffler space is selectively discharged to the outer muffler space depending on a flow rate of refrigerant discharged from the lower surface of the compression part.

### CROSS-REFERENCE TO RELATED APPLICATION

This application is a continuation application, under 35 U.S.C. § 111(a), of international application No. PCT/KR2024/005204, filed Apr. 18, 2024, which claims priority under 35 U.S.C. § 119 to Korean Patent Application No. 10-2023-0076347, filed Jun. 14, 2023, the disclosures of which are incorporated herein by reference in their entireties.

### TECHNICAL FIELD

The disclosure relates to a rotary compressor, and more particularly, to a rotary compressor having a muffler with variable capacity.

### BACKGROUND ART

A compressor is a mechanical device that compresses incoming gas, increases its pressure, and then discharges it. Depending on their operating principles, compressors may be classified into reciprocating compressors and rotating compressors.

The reciprocating compressor may include a recipro compressor, which converts the rotational motion of a motor into the linear reciprocating motion of a piston using a crank shaft and a connecting rod to suction and compress gas.

The rotating compressor may include a rotary compressor and a scroll compressor.

The rotary compressor may be configured so that refrigerant is sucked and compressed by a roller rotating inside a cylinder of a compression part by the rotational motion of a motor.

The scroll compressor may be configured so that refrigerant is sucked and compressed by an orbiting scroll rotating in a certain direction relative to a fixed scroll by the rotational motion of a motor.

In the rotary compressor, the refrigerant compressed by the compression part may be discharged into a casing, then, together with oil within the casing, may be discharged outside the casing through a refrigerant discharge pipe.

### DISCLOSURE OF INVENTION

### Technical Solution

According to an aspect of the disclosure, a rotary compressor may include: a casing; a motor disposed inside the casing; a compression part disposed below the motor; a plurality of refrigerant passages configured to penetrate the compression part along an edge of the compression part; an upper muffler disposed on an upper surface of the compression part and forming an upper muffler space that allows refrigerant to be introduced thereto along a vertical direction of the rotary compressor through the plurality of refrigerant passages; an inner muffler disposed on a lower surface of the compression part and forming an inner muffler space that prevents refrigerant from passing through at least one refrigerant passage among the plurality of refrigerant passages and allows the refrigerant to pass through remaining refrigerant passages among the plurality of refrigerant passages; an outer muffler disposed below the inner muffler and forming an outer muffler space, the outer muffler being in contact with a portion of the inner muffler and allowing the refrigerant from the inner muffler space prevented from passing through the at least one refrigerant passage to pass through; and a refrigerant discharge passage provided on a portion of the inner muffler contacting the outer muffler space and configured such that the refrigerant in the inner muffler space is selectively discharged to the outer muffler space depending on a flow rate of refrigerant discharged from the lower surface of the compression part.

The refrigerant discharge passage may be formed as a plurality of holes.

The plurality of holes may be formed with a perforation ratio of 20% to 80%.

The refrigerant discharge passage may be configured as a plate valve.

The lower surface of the compression part may include a discharge hole through which compressed refrigerant is discharged. The discharge hole may be located in the inner muffler space.

The plurality of refrigerant passages may include three refrigerant passages. The inner muffler may be configured such that the refrigerant from the inner muffler space passes through two refrigerant passages adjacent to the discharge hole in a direction of flow of the refrigerant discharged from the discharge hole among the three refrigerant passages, and the refrigerant is prevented from passing through a refrigerant passage far from the discharge hole along the direction of flow of the refrigerant.

The outer muffler may be configured such that the refrigerant from the outer muffler space passes through the refrigerant passage, which is far from the discharge hole and is prevented from passing through the inner muffler space.

The inner muffler may be formed in a dome shape and includes a plurality of inner convex portions formed at regular intervals along a circumferential direction of the inner muffler on a side surface of the inner muffler. The plurality of refrigerant passages through which the refrigerant is introduced to the inner muffler space may be located in the plurality of inner convex portions.

The outer muffler may be formed in a dome shape corresponding to the inner muffler and may include a plurality of outer convex portions formed at regular intervals along a circumferential direction of the outer muffler on a side surface of the outer muffler. A number of the plurality of outer convex portions may be at least one more than a number of the plurality of inner convex portions.

Based on the outer muffler and the inner muffler being coupled, all of the plurality of inner convex portions of the inner muffler may be coupled to the plurality of outer convex portions of the outer muffler. A non-coupled outer convex portion of the outer muffler that is not coupled to the plurality of inner convex portions of the inner muffler may form the outer muffler space.

The refrigerant discharge passage may be formed on a side surface of the inner muffler facing the non-coupled outer convex portion of the outer muffler.

The at least one refrigerant passage not communicating with the inner muffler space may be located in the non-coupled outer convex portion of the outer muffler that is not coupled with the plurality of inner convex portions of the inner muffler.

The inner muffler may further include a sub-refrigerant hole formed at a position corresponding to the non-coupled outer convex portion of the outer muffler.

The inner muffler may include first, second, and third inner convex portions. The outer muffler may include first, second, third, and fourth outer convex portions. Based on the inner muffler and the outer muffler being coupled, the first, second, and third inner convex portions may be coupled to the first, second, and third outer convex portions, and the fourth outer convex portions may form the outer muffler space.

A sum of a volume of the inner muffler space and a volume of the outer muffler space may be a rated volume.

### BRIEF DESCRIPTION OF DRAWINGS

These and/or other aspects, features, and advantages of certain embodiments of the disclosure will be more apparent from the following description taken in conjunction with the accompanying drawings, in which:

FIG. 1 is a perspective view illustrating a rotary compressor according to one or more embodiments of the disclosure.

FIG. 2 is a cross-sectional view illustrating the rotary compressor of FIG. 1 taken along line A-A according to one or more embodiments of the disclosure.

FIG. 3 is a cross-sectional view illustrating the rotary compressor of FIG. 1 taken along line B-B according to one or more embodiments of the disclosure.

FIG. 4 is a perspective view illustrating a compression part of a rotary compressor according to one or more embodiments of the disclosure.

FIG. 5 is a bottom view illustrating the compression part of the rotary compressor of FIG. 4 according to one or more embodiments of the disclosure.

FIG. 6 is a cross-sectional view illustrating the compression part of the rotary compressor of FIG. 4 according to one or more embodiments of the disclosure.

FIG. 7 is an exploded perspective view illustrating the compression part of the rotary compressor of FIG. 4 according to one or more embodiments of the disclosure.

FIG. 8 is a perspective view illustrating an inner muffler used in a rotary compressor according to one or more embodiments of the disclosure.

FIG. 9 is a perspective view illustrating the inner muffler of FIG. 8 from above according to one or more embodiments of the disclosure.

FIG. 10 is a perspective view illustrating an outer muffler used in a rotary compressor according to one or more embodiments of the disclosure.

FIG. 11 is a perspective view illustrating the outer muffler of FIG. 10 from above according to one or more embodiments of the disclosure.

FIG. 12 is a perspective view illustrating a state in which an inner muffler and an outer muffler of a rotary compressor are coupled according to one or more embodiments of the disclosure.

FIG. 13 is a cross-sectional view illustrating a lower muffler of FIG. 12 taken along line C-C according to one or more embodiments of the disclosure.

FIG. 14 is a perspective view illustrating an inner muffler of a rotary compressor according to one or more embodiments of the disclosure.

FIG. 15 is a perspective view illustrating a state in which an inner muffler and an outer muffler of a rotary compressor are coupled according to one or more embodiments of the disclosure.

FIG. 16 is a view illustrating a flow of refrigerant when a rotary compressor operates at low load according to one or more embodiments of the disclosure.

FIG. 17 is a view illustrating a flow of refrigerant when a rotary compressor operates at high load according to one or more embodiments of the disclosure.

FIG. 18 is a graph illustrating a flow rate of refrigerant passing through a plurality of refrigerant passages according to operating conditions of a rotary compressor according to one or more embodiments of the disclosure.

### BEST MODE FOR CARRYING OUT THE INVENTION

Various embodiments of this document and terms used herein are not intended to limit the technical features described in this document to specific embodiments, but should be understood to include various modifications, equivalents, or alternatives of the embodiments.

In connection with the description of the drawings, similar reference numbers may be used for similar or related components.

The singular form of a noun corresponding to an item may include one or more of the above item, unless the relevant context clearly indicates otherwise.

In this document, each of phrases such as “A or B,” “at least one of A and B,” “at least one of A or B,” “A, B, or C,” “at least one of A, B, and C,” “at least one of A, B, C” may include any one of the items listed together with the corresponding phrase, or any possible combination thereof.

The term “and/or” includes any element of a plurality of related described elements or a combination of a plurality of related described elements.

Terms such as “first,” “second,” “primary,” or “secondary” may be used simply to distinguish one component from other components, and do not limit the corresponding components in other respects (e.g., importance or order).

When a component (e.g., a first component) is said to be “coupled” or “connected” to another component (e.g., a second component), with or without the terms “functionally” or “communicatively,” it means that the component can be connected to the other component directly (e.g., wired), wirelessly, or through a third component.

Terms such as “include” or “have” are intended to designate the presence of features, numbers, steps, operations, components, parts, or combinations thereof described in the embodiment, but do not preclude the presence or addition of one or more other features, numbers, steps, operations, components, parts, or combination thereof.

When a component is said to be “connected,” “coupled,” “supported,” or “in contact” with another component, this means not only cases where the components are directly connected, coupled, supported, or contacted, but also cases where the components are indirectly connected, coupled, supported, or contacted through a third component.

When a component is said to be located “on” other component, this includes not only cases where the component is in contact with the other component, but also cases where another component exits between the two components.

Further, terms such as ‘leading end’, ‘rear end’, ‘upper side’, ‘lower side’, ‘top end’, ‘bottom end’, etc. used in the disclosure are defined with reference to the drawings. However, the shape and position of each component are not limited by these terms.

Hereinafter, a rotary compressor 1 according to one or more embodiments of the disclosure will be described in detail with reference to the attached drawings.

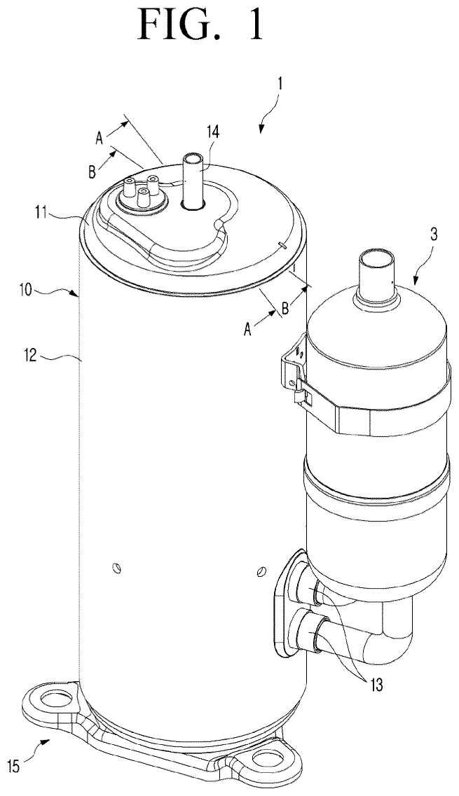

FIG. 1 is a perspective view illustrating a rotary compressor 1 according to one or more embodiments of the disclosure.

Referring to FIG. 1, a rotary compressor 1 according to one or more embodiments of the disclosure may include a casing 10.

The casing 10 may form an outer appearance of the rotary compressor 1. The casing 10 may be configured as a sealed container. The casing 10 may include a refrigerant inlet 13 through which refrigerant is introduced and a refrigerant discharge pipe 14 through which refrigerant is discharged.

The rotary compressor 1 may form a refrigeration cycle together with a condenser, an expansion valve, and an evaporator. In this case, the refrigerant inlet 13 may be connected to the evaporator, and the refrigerant discharge pipe 14 may be connected to the condenser.

An accumulator 3 may be disposed on one side of the rotary compressor 1. In other words, the accumulator 3 may be disposed on the outer surface of the casing 10. In this case, the refrigerant inlet 13 may be connected to the accumulator 3. The inlet pipe of the accumulator 3 may be connected to the evaporator. Therefore, the refrigerant discharged from the evaporator may be introduced into the rotary compressor 1 through the accumulator 3.

The casing 10 may include an upper casing 11 and a lower casing 12. The upper casing 11 may be joined to the upper end of the lower casing 12 to form the casing 10.

The joint between the upper casing 11 and the lower casing 12 may be sealed.

The refrigerant discharge pipe 14 may be provided in the upper casing 11. The refrigerant discharge pipe 14 may be provided at the upper end of the upper casing 11.

The refrigerant inlet 13 may be provided at the lower casing 12. The refrigerant inlet 13 may be connected to a compression part 40 disposed inside the lower casing 12. A low-temperature/low-pressure refrigerant may be introduced into the refrigerant inlet 13. Therefore, the refrigerant may be introduced into the compression part 40 through the refrigerant inlet 13.

The accumulator 3 may be disposed in the lower casing 12. In this case, the refrigerant inlet 13 may be connected to the discharge pipe of the accumulator 3.

A base 15 supporting the casing 10 may be provided at the bottom of the lower casing 12. The rotary compressor 1 may be disposed vertically to a support surface by the base 15.

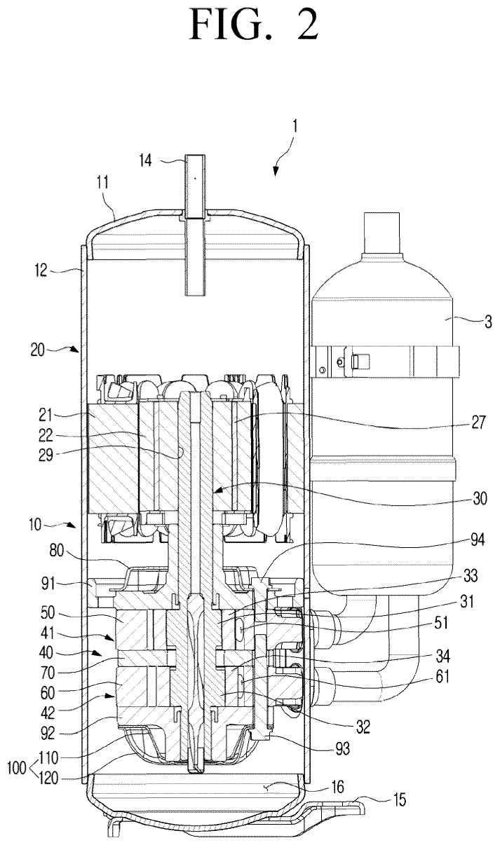

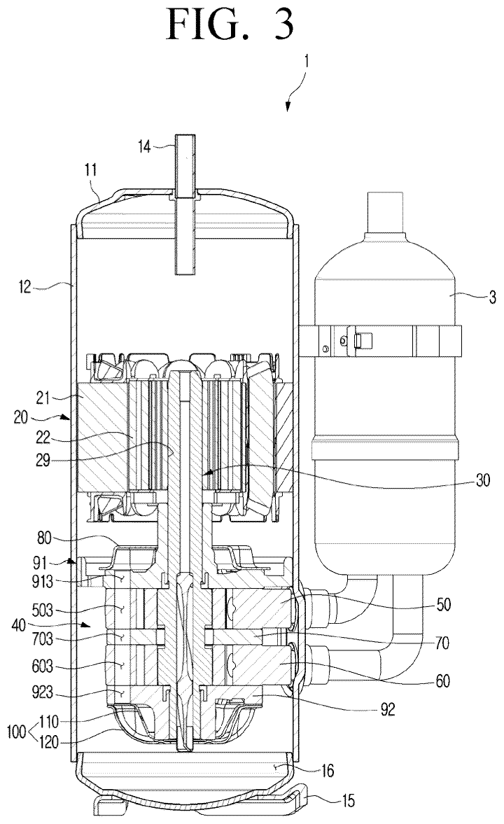

FIG. 2 is a cross-sectional view illustrating the rotary compressor 1 of FIG. 1 taken along line A-A. FIG. 3 is a cross-sectional view illustrating the rotary compressor 1 of FIG. 1 taken along line B-B.

Referring to FIGS. 2 and 3, the rotary compressor 1 according to an embodiment of the disclosure may include a casing 10, a motor 20, and a compression part 40.

The casing 10 may form the outer appearance of the rotary compressor 1, and may be formed as a cylindrical sealed container. The casing 10 may include a lower casing 12 provided with a refrigerant inlet 13 and an upper casing 11 provided with a refrigerant discharge pipe 14.

The casing 10 may be formed by connecting the upper casing 11 and the lower casing 12, and the interior of the casing 10 except for the refrigerant inlet 13 and the refrigerant discharge pipe 14 may be sealed. In other words, the refrigerant may be introduced into the interior of the casing 10 only through the refrigerant inlet 13 and may be discharged from the casing 10 to the outside only through the refrigerant discharge pipe 14.

The internal space of the casing 10 may accommodate high-pressure refrigerant discharged from the compression part 40. The refrigerant in the internal space of the casing 10 may be discharged to the outside through the refrigerant discharge pipe 14.

An oil reservoir 16 for receiving oil may be provided at the lower portion of the casing 10.

An accumulator 3 may be disposed on the outer surface of the casing 10. At this time, the refrigerant inlet 13 may be connected to the discharge pipe of the accumulator 3.

The motor 20 may be arranged in the upper side inside the casing 10. The motor 20 may include a stator 21 and a rotor 22.

The stator 21 of the motor 20 may be fixed to the inner circumferential surface of the casing 10. A plurality of oil return passages may be provided between the outer circumferential surface of the stator 21 and the inner circumferential surface of the casing 10. The plurality of oil return passages may be formed at regular intervals along the outer circumferential surface of the stator 21.

Oil from the upper side of the motor 20 may flow to the lower side of the motor 20 through the plurality of oil return passages provided between the stator 21 and the casing 10. Oil that has moved to the lower side of the motor 20 may be collected in the oil reservoir 16 provided at the lower portion of the casing 10.

The rotor 22 may be rotatably disposed at the center of the stator 21. The rotor 22 may be disposed so as to maintain a certain gap with the inner surface of the stator 21.

A shaft hole 29, which penetrates the rotor 22 in the longitudinal direction, may be provided at the center of the rotor 22. A plurality of refrigerant holes 27 may be provided around the shaft hole 29 of the rotor 22. The plurality of refrigerant holes 27 may be formed to penetrate the rotor 22 in the longitudinal direction, i.e., in the up-down direction.

The refrigerant discharged from the compression part 40 below the motor 20 may move to the upper side of the motor 20 through the gap between the rotor 22 and the stator 21 and the plurality of refrigerant holes 27.

A drive shaft 30 may be inserted into and fixed in the shaft hole 29 penetrating the center of the rotor 22. Therefore, when power is applied to the motor 20, the rotor 22 may rotate by the electromagnetic force acting between the stator 21 and the rotor 22. When the rotor 22 rotates, the drive shaft 30 may rotate integrally with the rotor 22.

When the drive shaft 30 rotates by the motor 20, the compression part 40 may operate to compress the refrigerant.

The drive shaft 30 may be formed to extend downward from the motor 20. The lower portion of the drive shaft 30 extending downward from the motor 20 may be connected to the compression part 40. The lower portion of the drive shaft 30 may be configured as a crank shaft to operate the compression part 40.

The crank shaft of the drive shaft 30 may include two eccentric portions, i.e., an upper eccentric portion 31 and a lower eccentric portion 32. Therefore, when the drive shaft 30 rotates, the upper eccentric portion 31 and the lower eccentric portion 32 of the crank shaft may rotate integrally with the drive shaft 30.

The upper eccentric portion 31 may be formed in a cylindrical shape having a diameter larger than the diameter of the drive shaft 30. The center line of the upper eccentric portion 31 may be eccentric with the center line of the drive shaft 30. An upper roller 33 may be disposed on the outer circumferential surface of the upper eccentric portion 31. In other words, the upper eccentric portion 31 may be inserted into the upper roller 33.

The lower eccentric portion 32 may be disposed below the upper eccentric portion 31, and may be formed in the same manner as the upper eccentric portion 31. In other words, the lower eccentric portion 32 may be formed in a cylindrical shape having a diameter larger than the diameter of the drive shaft 30. The center line of the lower eccentric portion 32 may be eccentric with the center line of the drive shaft 30. A lower roller 34 may be disposed on the outer circumferential surface of the lower eccentric portion 32. In other words, the lower eccentric portion 32 may be inserted into the lower roller 34.

The lower eccentric portion 32 may be configured to be eccentric in a different direction from the upper eccentric portion 31 with respect to the center line of the drive shaft 30. For example, the lower eccentric portion 32 may be eccentric 180 degrees opposite to the upper eccentric portion 31 with respect to the center line of the drive shaft 30.

The drive shaft 30 may be rotatably supported by an upper flange 91 and a lower flange 92.

The upper flange 91 may be disposed to be fixed to the inner surface of the casing 10 below the motor 20. The upper flange 91 may be disposed above the upper eccentric portion 31. In other words, the upper flange 91 may be disposed to support the drive shaft 30 between the motor 20 and the upper eccentric portion 31.

The lower flange 92 may be disposed to support the lower end portion of the drive shaft 30 below the lower eccentric portion 32. The lower flange 92 may be fixed to the upper flange 91.

The compression part 40 may be disposed below the motor 20. The compression part 40 may be configured to compress the refrigerant and discharge the compressed refrigerant to the upper side of the compression part 40 according to the rotation of the drive shaft 30.

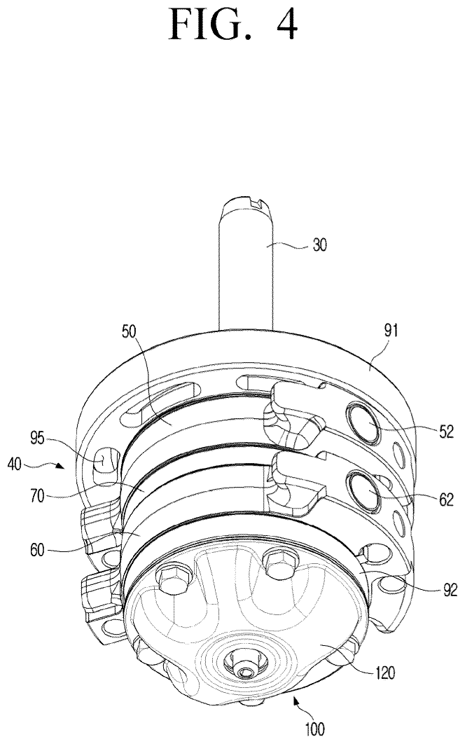

Hereinafter, the compression part 40 of the rotary compressor 1 according to an embodiment of the disclosure will be described in detail with reference to FIGS. 4 to 7.

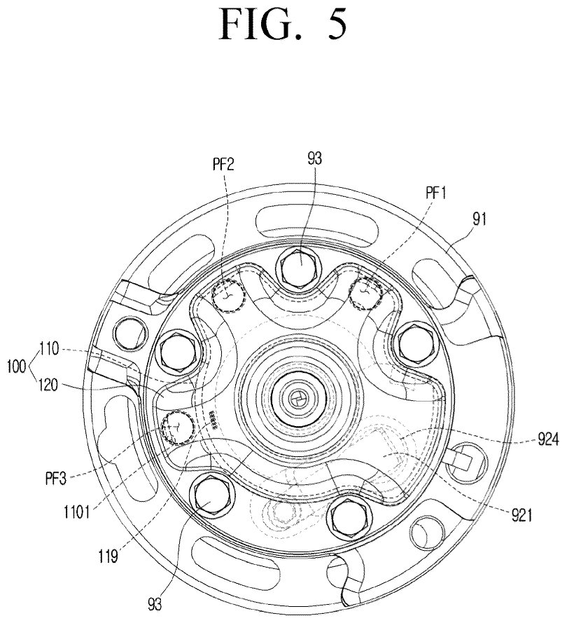

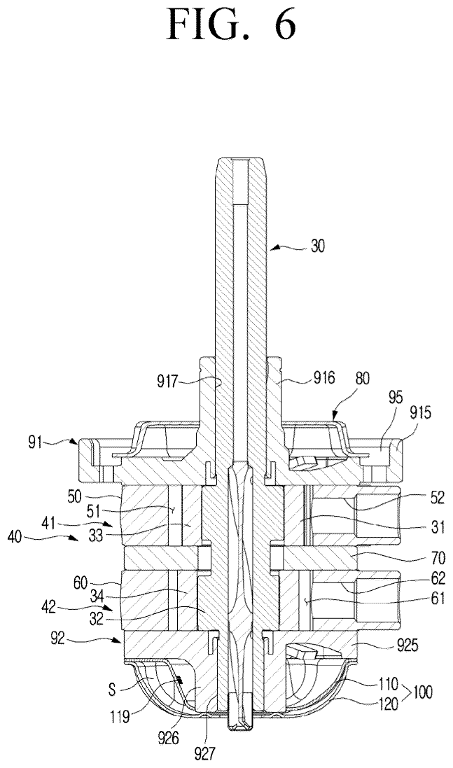

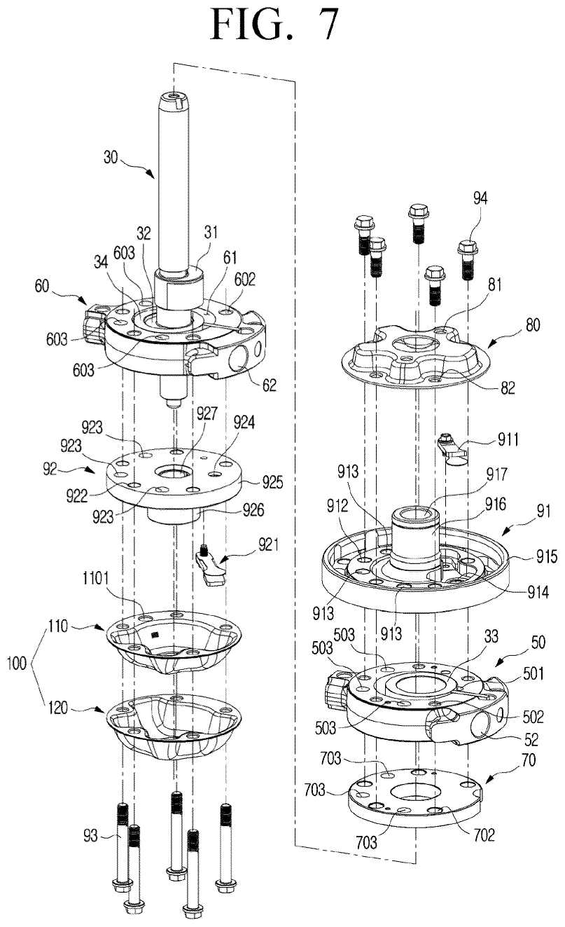

FIG. 4 is a perspective view illustrating a compression part 40 of a rotary compressor 1 according to one or more embodiments of the disclosure. FIG. 5 is a bottom view illustrating the compression part 40 of the rotary compressor 1 of FIG. 4. FIG. 6 is a cross-sectional view illustrating the compression part 40 of the rotary compressor 1 of FIG. 4. FIG. 7 is an exploded perspective view illustrating the compression part 40 of the rotary compressor 1 of FIG. 4.

The compression part 40 may be disposed at the lower portion of the casing 10, and may be configured to be operated by the drive shaft 30 that rotates by the motor 20 to suck in, compress, and discharge refrigerant.

Referring to FIGS. 4 to 7, the compression part 40 may be disposed between the upper flange 91 and the lower flange 92 that rotatably support the drive shaft 30.

The compressor 101 may include an upper compression part 41, a lower compression part 42, and an intermediate plate 70 provided between the upper compression part 41 and the lower compression part 42.

The upper compression part 41 may be configured to suck and compress refrigerant in response to the rotation of the drive shaft 30. The lower compression part 42 may be provided below the upper compression part 41 and may be configured to suck and compress refrigerant in response to the rotation of the drive shaft 30.

The upper compression part 41 may be disposed on the upper surface of the intermediate plate 70 and may include an upper cylinder 50 having a flat-plate shape. The upper cylinder 50 may include a compression chamber. The compression chamber may be formed as a hollow 51 having a circular cross-section.

The upper roller 33 disposed on the upper eccentric portion 31 of the drive shaft 30 may be accommodated and rotated within the hollow 51 of the upper cylinder 50.

The upper compression part 41 may include a refrigerant inlet passage 52 connected to the refrigerant inlet 13 provided in the casing 10. The refrigerant inlet passage 52 may be formed in the upper cylinder 50.

The refrigerant inlet passage 52 may be formed as a through hole connecting the hollow 51 of the upper cylinder 50 and the outer circumferential surface of the upper cylinder 50. Therefore, the refrigerant may be introduced into the hollow 51 of the upper cylinder 50 through the refrigerant inlet 13 and the refrigerant inlet passage 52.

The upper compression part 41 may include an upper discharge port 501 through which the compressed refrigerant is discharged. The upper discharge port 501 may be provided on the upper surface of the upper cylinder 50.

When the upper roller 33 rotates by the drive shaft 30, the refrigerant may be introduced into the hollow 51 of the upper cylinder 50 through the refrigerant inlet passage 52, compressed by the upper roller 33, and then discharged through the upper discharge port 501.

The lower compression part 42 may be disposed on the lower surface of the intermediate plate 70 and may have a lower cylinder 60 having a flat plate shape. The lower cylinder 60 may include a compression chamber. The compression chamber may be formed as a hollow 61 having a circular cross-section.

The lower roller 34 disposed in the lower eccentric portion 32 of the drive shaft 30 may be accommodated and rotated in the hollow 61 of the lower cylinder 60.

The lower compression part 42 may include a refrigerant inlet passage 62 connected to the refrigerant inlet 13 provided in the casing 10. The refrigerant inlet passage 62 may be formed in the lower cylinder 60.

The refrigerant inlet passage 62 may be formed as a through hole connecting the hollow 61 of the lower cylinder 60 and the outer circumferential surface of the lower cylinder 60. Therefore, the refrigerant may be introduced into the hollow 61 of the lower cylinder 60 through the refrigerant inlet 13 and the refrigerant inlet passage 62.

The lower compression part 42 may include a lower discharge port through which the compressed refrigerant is discharged. The lower discharge port may be provided on the lower surface of the lower cylinder 60. Therefore, the refrigerant compressed by the lower compression part 42 may be discharged below the lower compression part 42 through the lower discharge port.

When the lower roller 34 rotates by the drive shaft 30, the refrigerant may be introduced into the hollow 61 of the lower cylinder 60 through the refrigerant inlet passage 62, compressed by the lower roller 34, and then discharged through the lower discharge port.

The low-pressure refrigerant may be supplied to the upper compression part 41 and the lower compression part 42 through the accumulator 3.

The intermediate plate 70 may be disposed between the upper cylinder 50 and the lower cylinder 60. The intermediate plate 70 may be formed in a flat plate shape.

Accordingly, the lower cylinder 60, the intermediate plate 70, and the upper cylinder 50 may be laminated to form the compression part 40. The lower cylinder 60, the intermediate plate 70, and the upper cylinder 50 may be integrally connected by a plurality of bolts 93.

The upper flange 91 may be disposed on the upper surface of the upper cylinder 50. The upper flange 91 may be fixed to the inner circumferential surface of the casing 10.

Therefore, when the upper cylinder 50 is fixed to the upper flange 91, the upper cylinder 50 may be fixed to the casing 10.

The upper flange 91 may be configured to rotatably support the drive shaft 30 and cover the upper side of the hollow 51 of the upper cylinder 50.

The upper flange 91 may be provided with an upper discharge hole 914 communicating with the upper discharge port 501 of the upper cylinder 50. Accordingly, the refrigerant discharged through the upper discharge port 501 of the upper cylinder 50 may be discharged to the upper side of the upper flange 91 through the upper discharge hole 914 of the upper flange 91.

The upper flange 91 may include an upper discharge valve 911 configured to open and close the upper discharge port 914. Therefore, the upper discharge hole 914 of the upper flange 91 may be opened and closed by the upper discharge valve 911. When the refrigerant introduced into the upper cylinder 50 is compressed, the upper discharge valve 911 may be opened so that the refrigerant may be discharged to the upper side of the upper flange 91.

An upper muffler 80 may be disposed on the upper side of the upper flange 91. The upper muffler 80 may be configured to reduce noise generated by the refrigerant discharged through the upper discharge hole 914 of the upper flange 91.

The upper flange 91 may include a plurality of bolt holes 912 provided along the circumferential direction of the upper flange 91.

The upper flange 91 may include a plurality of refrigerant holes 913 provided along the circumferential direction of the upper flange 91. The refrigerant discharged from the lower cylinder 60 may flow to the upper side of the upper flange 91 through the plurality of refrigerant holes 913.

The upper muffler 80 may include a plurality of refrigerant openings 81 through which the refrigerant may pass. The refrigerant passing through the upper flange 91 may be discharged into the space between the motor 20 and the compression part 40 through the plurality of refrigerant openings 81 of the upper muffler 80.

The upper muffler 80 may be provided with a plurality of bolt holes 82 corresponding to the plurality of bolt holes 912 of the upper flange 91 along the edge of the upper muffler 80.

A plurality of openings 95 may be provided at the edge of the upper flange 91. The plurality of openings 95 may be formed around the upper muffler 80 disposed on the upper flange 91. The plurality of openings 95 may be formed to penetrate the upper flange 91 up and down. Oil may move to the oil reservoir 16 at the lower portion of the casing 10 through the plurality of openings 95.

The upper flange 91 may include an upper flange part 915, an upper boss 916, and an upper bearing 917.

The upper flange part 915 may be formed in a disk shape. The upper flange part 915 may be formed to cover the hollow 51 of the upper cylinder 50. The upper flange part 915 may be formed to have a diameter corresponding to the inner circumferential surface of the casing 10. Therefore, the upper flange 91 may be fixed to the inner circumferential surface of the casing 10.

The upper flange part 915 may include the upper discharge hole 914 communicating with the upper discharge port 501 of the upper cylinder 50. Therefore, the refrigerant discharged through the upper discharge port 501 of the upper cylinder 50 may be discharged to the upper side of the upper flange part 915 through the upper discharge hole 914 of the upper flange part 915.

The upper discharge valve 911 may be provided in the upper discharge hole 914 of the upper flange part 915. Accordingly, the upper discharge hole 914 of the upper flange part 915 may be opened and closed by the upper discharge valve 911. When the refrigerant introduced into the upper cylinder 50 is compressed above a certain pressure, the upper discharge valve 911 may be opened so that the refrigerant may be discharged to the upper side of the upper flange part 915.

The upper boss 916 may be vertically extended from the center of the upper flange part 915. The upper boss 916 may be vertically extended upward from the upper flange part 915. A through hole may be formed in the center of the upper boss 916.

The upper bearing 917 may be disposed in the through hole of the upper boss 916 and may rotatably support the drive shaft 30. Any type of bearing may be used as the upper bearing 917 as long as it can rotatably support the drive shaft 30. In the case of this disclosure, a sliding bearing may be used as the upper bearing 917.

The plurality of bolt holes 912 and the plurality of refrigerant holes 913 may be provided in the upper flange part 915 around the upper boss 916. The plurality of openings 95 may be provided on the edge of the upper flange part 915 outside the plurality of bolt holes 912.

The upper cylinder 50 may be provided with a plurality of tap holes 502 corresponding to the plurality of bolt holes 912 of the upper flange part 915. In addition, the upper cylinder 50 may include a plurality of refrigerant holes 503 corresponding to the plurality of refrigerant holes 913 of the upper flange 91.

When the plurality of bolts 94 are fastened to the plurality of tap holes 502 of the upper cylinder 50, the upper muffler 80 and the upper flange 91 may be fixed to the upper cylinder 50 by the plurality of bolts 94.

The noise of the refrigerant discharged through the upper discharge hole 914 of the upper flange 91 may be reduced as the refrigerant passes through the interior of the upper muffler 80, and then the refrigerant may be discharged to the upper side of the upper muffler 80, i.e., to the space between the motor 20 and the compression part 40 through the plurality of refrigerant openings 81 of the upper muffler 80.

The lower flange 92 may be disposed on the lower surface of the lower cylinder 60. The lower flange 92 may be configured to rotatably support the lower end portion of the drive shaft 30 and cover the lower side of the hollow 61 of the lower cylinder 60.

The lower flange 92 may be provided with a discharge hole 924 communicating with the lower discharge port of the lower cylinder 60. Accordingly, the refrigerant discharged through the lower discharge port of the lower cylinder 60 may be discharged to the lower side of the lower flange 92 through the discharge hole 924 of the lower flange 92.

The lower flange 92 may include a discharge valve 921 configured to open and close the discharge hole 924. Therefore, the discharge hole 924 of the lower flange 92 may be opened and closed by the discharge valve 921. When the refrigerant introduced into the lower cylinder 60 is compressed to a certain pressure or higher, the discharge valve 921 may be opened so that the refrigerant may be discharged to the lower side of the lower flange 92.

A lower muffler 100 may be disposed on the lower side of the lower flange 92. The lower muffler 100 may form a space that receives the refrigerant discharged through the discharge hole 924 of the lower flange 92.

The lower muffler 100 may be configured to reduce noise generated by the refrigerant discharged through the discharge hole 924 of the lower flange 92. The lower muffler 100 may be configured so that its internal volume varies depending on the load applied to the rotary compressor 1.

In addition, the lower flange 92 may be configured so that the refrigerant discharged through the discharge hole 924 of the lower flange 92 is prevented from being discharged below the lower muffler 100.

The lower flange 92 may include a plurality of first bolt holes 922 provided along the circumferential direction of the lower flange 92.

The lower flange 92 may include a plurality of refrigerant holes 923 provided along the circumferential direction of the lower flange 92. The refrigerant discharged from the discharge hole 924 of the lower flange 92 may flow to the upper side of the lower flange 92 through the lower muffler 100 and the plurality of refrigerant holes 923.

In detail, the plurality of refrigerant holes 923 of the lower flange 92 may be formed to coincide with the plurality of refrigerant holes 603 of the lower cylinder 60, the plurality of refrigerant holes 703 of the intermediate plate 70, the plurality of refrigerant holes 503 of the upper cylinder 50, and the plurality of refrigerant holes 913 of the upper flange 91.

The plurality of refrigerant holes 923 of the lower flange 92 may be communicated with the discharge hole 924 by the lower muffler 100.

Accordingly, the refrigerant discharged from the discharge hole 924 of the lower flange 92 may move to the plurality of refrigerant holes 923 of the lower flange 92 by the lower muffler 100. The refrigerant introduced into the plurality of refrigerant holes 923 of the lower flange 92 may move to the space formed by the upper flange 91 and the upper muffler 80 through the plurality of refrigerant holes 603 of the lower cylinder 60, the plurality of refrigerant holes 703 of the intermediate plate 70, the plurality of refrigerant holes 503 of the upper cylinder 50, and the plurality of refrigerant holes 913 of the upper flange 91.

Therefore, the plurality of refrigerant holes 923 of the lower flange 92, the plurality of refrigerant holes 603 of the lower cylinder 60, the plurality of refrigerant holes 703 of the intermediate plate 70, the plurality of refrigerant holes 503 of the upper cylinder 50, and the plurality of refrigerant holes 913 of the upper flange 91, which are communicated in the vertical direction, may form a plurality of refrigerant passages PF1, PF2, and PF3 through which the refrigerant discharged from the lower compression part 42 moves to the space of the upper muffler 80. In other words, one refrigerant passage PF1, PF2, or PF3 may be formed by the refrigerant hole 923 of the lower flange 92, the refrigerant hole 603 of the lower cylinder 60, the refrigerant hole 703 of the intermediate plate 70, the refrigerant hole 503 of the upper cylinder 50, and the refrigerant hole 913 of the upper flange 91, which are arranged in a straight line.

The plurality of refrigerant passages PF1, PF2, and PF3 may be arranged in the direction of the flow of the refrigerant discharged from the discharge hole 924. In this embodiment, a refrigerant passage closest to the discharge hole 924 may be referred to as a first refrigerant passage PF1, and a refrigerant passage farthest from the discharge hole 924 may be referred to as a third refrigerant passage PF3. A refrigerant passage located between the first refrigerant passage and the third refrigerant passage may be referred to as a second refrigerant passage PF2.

The refrigerant in the space between the upper flange 91 and the upper muffler 71 may move to the upper side of the upper muffler 80 through the plurality of openings 81 of the upper muffler 80.

The lower muffler 100 may not include openings or holes through which the refrigerant can be discharged. Therefore, the refrigerant discharged through the discharge hole 924 of the lower flange 92 may not be discharged to the lower side of the compression part 40 through the lower muffler 100.

The lower flange 92 may include a flange part 925, a boss 926, and a bearing 927.

The flange part 925 may be formed in a disk shape. The flange part 925 may be formed to cover the hollow 61 of the lower cylinder 60. The flange part 925 may be formed in a size corresponding to the lower cylinder 60.

The flange part 925 may include the discharge hole 924 communicating with the lower discharge port of the lower cylinder 60. Therefore, the refrigerant discharged through the lower discharge port of the lower cylinder 60 may be discharged below the flange part 925 through the discharge hole 924 of the flange part 925.

The discharge valve 921 may be provided in the discharge hole 924 of the flange part 925. Therefore, the discharge hole 924 of the flange part 925 may be opened and closed by the discharge valve 921. When the refrigerant introduced into the lower cylinder 60 is compressed above a certain pressure, the discharge valve 921 may be opened so that the refrigerant may be discharged below the flange part 925.

The boss 926 may extend vertically from the center of the flange part 925. The boss 926 may extend vertically downward from the flange part 925. A through hole may be formed in the center of the boss 926.

The bearing 927 may be disposed in the through hole of the boss 926 and may rotatably support the drive shaft 30. Accordingly, the drive shaft 30 may be rotatably supported by the bearing 927 and the upper bearing 917. Any type of bearing may be used as the bearing 927 as long as it can rotatably support the drive shaft 30. In the case of this disclosure, a sliding bearing may be used as the bearing 927.

The plurality of first bolt holes 922 and the plurality of refrigerant holes 923 may be provided in the flange part 925 around the boss 926.

The lower cylinder 60 may be provided with a plurality of bolt holes 602 corresponding to the plurality of first bolt holes 922 of the flange part 925. In addition, the lower cylinder 60 may include the plurality of refrigerant holes 603 corresponding to the plurality of refrigerant holes 923 of the lower flange 92.

The lower muffler 100 may be disposed on the lower surface of the flange part 925 of the lower flange 92. The lower muffler 100 may be configured so that the volume of the internal space containing the refrigerant varies depending on the load applied to the rotary compressor 1.

The lower muffler 100 may include an inner muffler 110 and an outer muffler 120.

The inner muffler 110 and the outer muffler 120 may be connected to form the lower muffler 100. In other words, by disposing the inner muffler 110 inside the outer muffler 120, the lower muffler 100 may be formed.

The inner muffler 110 may be disposed on the lower surface of the compression part 40 and may be configured to form an inner muffler space that is not communicated with at least one of the plurality of refrigerant passages PF1, PF2, and PF3 and is communicated with the remaining refrigerant passages.

The outer muffler 120 may be disposed below the inner muffler 110 and may form an outer muffler space that communicates with the at least one refrigerant passage that is not communicated with the inner muffler space.

A refrigerant discharge passage 119 may be provided between the inner muffler 110 and the outer muffler 120. The refrigerant discharge passage 119 may be provided in a portion of the inner muffler 110 that is in contact with the outer muffler space, and may be configured so that the refrigerant in the inner muffler space may be selectively discharged to the outer muffler space depending on the flow rate of the refrigerant discharged from the lower surface of the compression part 40.

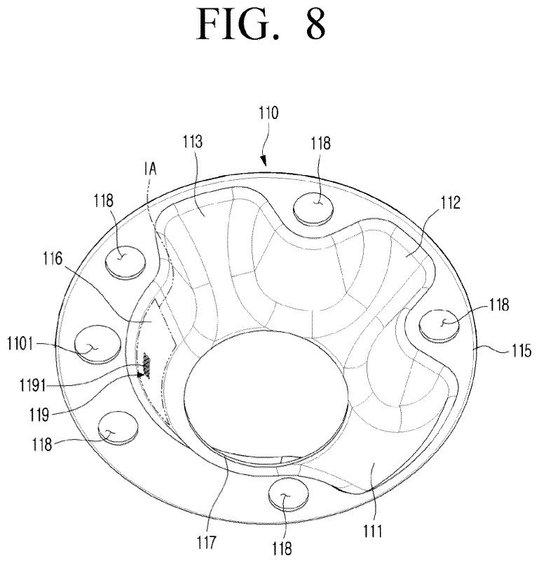

Hereinafter, the lower muffler 100 will be described in detail with reference to FIGS. 8 to 13.

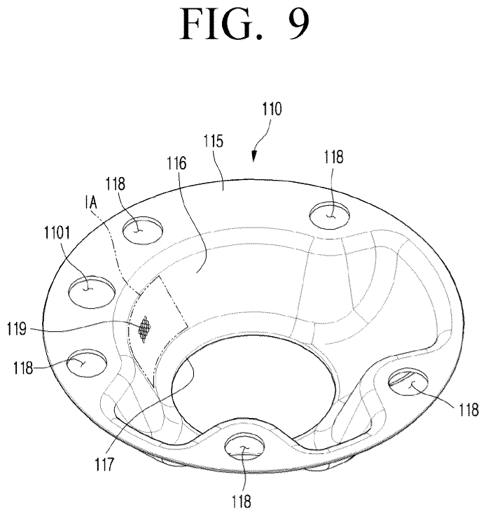

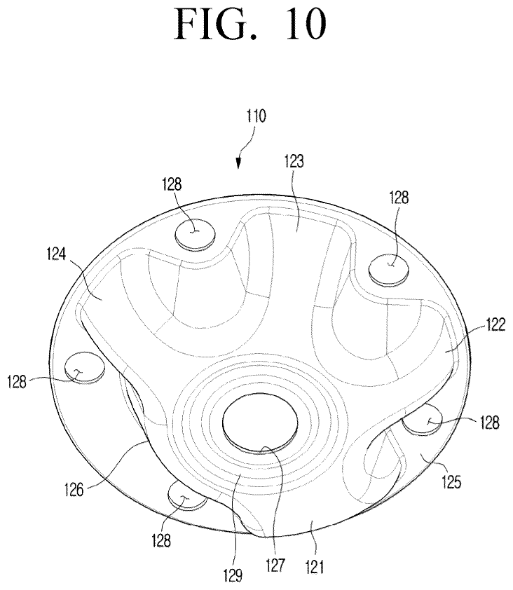

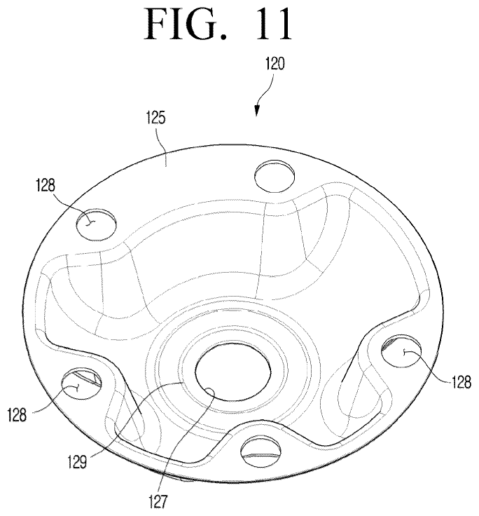

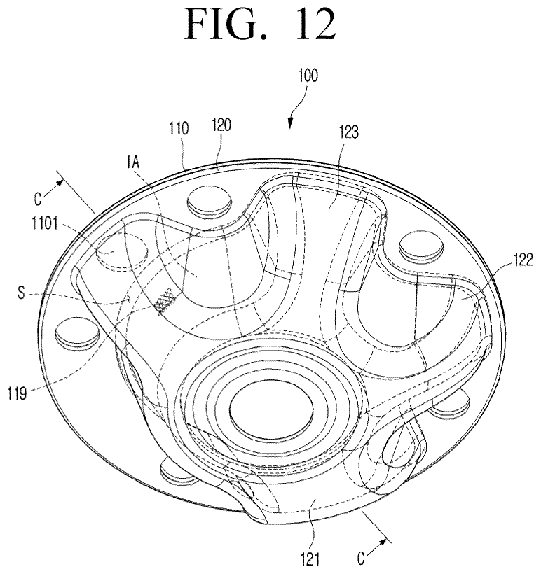

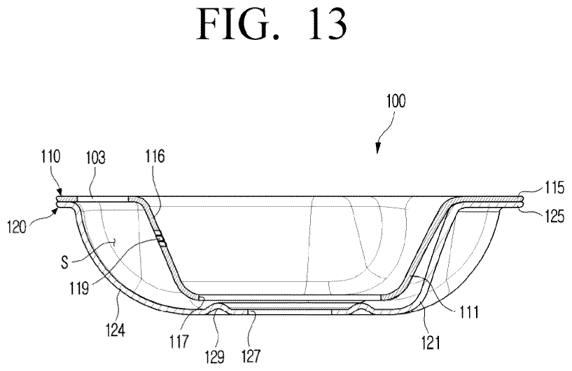

FIG. 8 is a perspective view illustrating an inner muffler 110 used in a rotary compressor 1 according to one or more embodiments of the disclosure. FIG. 9 is a perspective view illustrating the inner muffler 110 of FIG. 8 from above. FIG. 10 is a perspective view illustrating an outer muffler 120 used in a rotary compressor 1 according to one or more embodiments of the disclosure. FIG. 11 is a perspective view illustrating the outer muffler 120 of FIG. 10 from above. FIG. 12 is a perspective view illustrating a state in which an inner muffler 110 and an outer muffler 120 of a rotary compressor 1 are coupled according to one or more embodiments of the disclosure. FIG. 13 is a cross-sectional view illustrating a lower muffler 100 of FIG. 12 taken along line C-C.

Referring to FIGS. 8 and 9, the inner muffler 110 may be formed in a roughly dome shape. The inner muffler 110 may include a plurality of inner convex portions 111, 112, and 113 formed at regular intervals along the circumferential direction of the inner muffler 110 on the side surface of the inner muffler 110.

In detail, the inner muffler 110 may be formed in a shape including a dome portion in which the central portion of a disc protrudes downward in a roughly dome shape. The plurality of inner convex portions 111, 112, and 113 may be formed on the side surface of the dome portion.

In addition, the inner muffler 110 may include a plurality of second bolt holes 118 formed at regular intervals along the edge thereof. The plurality of second bolt holes 118 may be formed to correspond to the plurality of first bolt holes 922 of the lower flange 92.

In addition, the inner muffler 110 may include a sub-refrigerant hole 1101. The sub-refrigerant hole 1101 may be formed between the plurality of second bolt holes 118.

For example, the inner muffler 110 may include an inner fixing plate 115 and an inner dome portion 116.

The inner fixing plate 115 may be formed in an approximately ring shape. The inner fixing plate 115 may include an outer circumferential surface formed in a circular shape and an inner circumferential surface concentric with the outer circumferential surface and having a smaller diameter. The inner circumferential surface of the inner fixing plate 115 may include a plurality of inner concave portions. The plurality of inner concave portions may be formed concavely from the inner circumferential surface of the inner fixing plate 115 toward the outer circumferential surface thereof. The plurality of inner concave portions may be formed to correspond to the plurality of inner convex portions 111, 112, and 113 of the inner dome portion 116. The plurality of inner concave portions may be formed as a curve corresponding to the plurality of inner convex portions 111, 112, and 113 of the inner dome portion 116, respectively.

The inner fixing plate 115 may be fixed to the flange part 925 of the lower flange 92. The inner fixing plate 115 may include the plurality of second bolt holes 118. The plurality of second bolt holes 118 may be formed to correspond to the plurality of first bolt holes 922 of the lower flange 92. Some of the plurality of second bolt holes 118 may be formed between the plurality of inner convex portions 111, 112, and 113. In this embodiment, two second bolt holes 118 may be formed between three inner convex portions 111, 112, and 113.

The inner muffler 110 may include the sub-refrigerant hole 1101. The sub-refrigerant hole 1101 may be formed in the inner fixing plate 115. The sub-refrigerant hole 1101 may be formed between the plurality of second bolt holes 118.

The sub-refrigerant hole 1101 may be formed to communicate with one of the plurality of refrigerant passages PF1, PF2, and PF3 when the inner muffler 110 is disposed on the lower surface of the lower flange 92, i.e., the lower surface of the compression part 40. In detail, the sub-refrigerant hole 1101 may be formed to coincide with one of the plurality of refrigerant holes 923 of the lower flange 92.

The inner muffler 110 may include at least one sub-refrigerant hole 1101. In this embodiment, the inner muffler 110 includes one sub-refrigerant hole 1101, but the disclosure is not limited thereto. The inner muffler 110 according to one or more embodiments of the disclosure may include two or more sub-refrigerant holes 1101.

The inner dome portion 116 may be formed by extending downward from the inner circumferential surface of the inner fixing plate 115. The inner dome portion 116 may be formed to protrude from the lower surface of the inner fixing plate 115 in a roughly dome shape. The plurality of inner convex portions 111, 112, and 113 may be formed at regular intervals in the circumferential direction on the side surface of the inner dome portion 116. The plurality of inner convex portions 111, 112, and 113 may be formed as curved surfaces that protrude toward the outside of the inner dome portion 116.

As illustrated in FIGS. 8 and 9, the plurality of inner convex portions 111, 112, and 113 may protrude from the inner dome portion 116 toward the outer circumferential surface of the inner fixing plate 115. Therefore, the inner space of the inner dome portion 116 may be formed in a concave and convex shape. The inner space of the inner dome portion 116 may form the inner muffler space in which refrigerant is contained.

The plurality of inner convex portions 111, 112, and 113 may be formed to correspond to the discharge hole 924 and the plurality of refrigerant passages PF1, PF2, and PF3 of the compression part 40. In detail, the plurality of inner convex portions 111, 112, and 113 may be formed so that when the inner muffler 110 is disposed on the lower surface of the lower flange 92, the plurality of inner convex portions 111, 112, and 113 cover the discharge hole 924 and the plurality of refrigerant holes 923 of the lower flange 92. Accordingly, some of the plurality of refrigerant passages PF1, PF2, and PF3 of the compression part 40 that communicate with the inner muffler space may be located in the plurality of inner convex portions 111, 112, and 113. In addition, the discharge hole 924 of the compression part 40 may be positioned to correspond to one of the plurality of inner convex portions 111, 112, and 113.

For example, the inner muffler 110 may be configured so that the inner muffler space formed by the plurality of inner convex portions 111, 112, and 113 communicates with two refrigerant passages PF1 and PF2 adjacent to the discharge hole 924 in the direction of flow of the refrigerant discharged from the discharge hole 924 among the three refrigerant passages. In addition, the inner muffler 110 may be configured so as not to communicate with the refrigerant passage PF3 far from the discharge hole 924 in the direction of flow of the refrigerant.

A through hole 117 may be provided at the lower end of the inner dome portion 116. The boss 926 of the lower flange 92 may be inserted into the through hole 117 of the inner dome portion 116. Accordingly, the refrigerant discharged from the discharge hole 924 of the lower flange 92 may be accommodated in the inner muffler space formed by the inner dome portion 116 and the boss 926 of the lower flange 92.

The inner muffler 110 may include a refrigerant discharge passage 119. The refrigerant discharge passage 119 may be formed in the inner dome portion 116. The refrigerant discharge passage 119 may be formed in a portion of the inner dome portion 116 where the plurality of inner convex portions 111, 112, and 113 are not formed.

The refrigerant discharge passage 119 may be configured so that refrigerant may selectively pass therethrough depending on the pressure of the inner space of the inner muffler 110. In other words, the refrigerant discharge passage 119 may be configured so that refrigerant in the inner muffler space may be selectively discharged to the outside of the inner muffler 110 depending on the flow rate of the refrigerant discharged from the discharge hole 924 of the lower flange 92. For example, when a large amount of refrigerant is discharged from the discharge hole 924, the refrigerant may be discharged to the outside of the inner muffler 110 through the refrigerant discharge passage 119. When the amount of refrigerant discharged from the discharge hole 924 is small, the refrigerant may not be discharged to the outside of the inner muffler 110 through the refrigerant discharge passage 119.

The refrigerant discharge passage 119 may be formed as a plurality of holes 1191 in the inner dome portion 116 of the inner muffler 110. The plurality of holes 1191 may be formed with a perforation ratio of 20% to 80%. The perforation ratio may be defined based on the area IA of the inner dome portion 116 corresponding to a non-coupled outer convex portion 124 of the outer muffler 120.

The upper end of the inner muffler 110 may be formed so as not to protrude above the lower surface of the lower flange 92. In detail, the inner fixing plate 115 of the inner muffler 110 may not protrude above the lower surface of the flange part 925 of the lower flange 92 but may be positioned below it. In other words, the upper surface of the inner fixing plate 115 of the inner muffler 110 may contact the lower surface of the flange part 925 of the lower flange 92.

The upper surface of the inner fixing plate 115 of the inner muffler 110 may be formed so as not to contact the side surface of the flange part 925 of the lower flange 92.

When the inner fixing plate 115 does not contact the side surface of the flange part 925 of the lower flange 92, pressure by the inner muffler 110 may not be applied to the bearing 927 disposed in the lower flange 92. In other words, the inner muffler 110 may be formed as a flat muffler.

The outer muffler 120 may be formed in a shape corresponding to the inner muffler 110.

Referring to FIGS. 10 and 11, the outer muffler 120 may be formed in an approximately dome shape. The outer muffler 120 may include a plurality of outer convex portions 121, 122, 123, and 124 formed at regular intervals along the circumferential direction of the outer muffler 120 on the side surface of the outer muffler 120.

In detail, the outer muffler 120 may be formed in a shape including a dome portion in which the central portion of a disc protrudes downward in a roughly dome shape. The plurality of outer convex portions 121, 122, 123, and 124 may be formed on the side surface of the dome portion.

In addition, the outer muffler 120 may include a plurality of third bolt holes 128 formed at regular intervals along the edge thereof. The plurality of third bolt holes 128 may be formed to correspond to the plurality of first bolt holes 922 of the lower flange 92.

For example, the outer muffler 120 may include an outer fixing plate 125 and an outer dome portion 126.

The outer fixing plate 125 may be formed in an approximately ring shape. The outer fixing plate 125 may include an outer circumferential surface formed in a circular shape and an inner circumferential surface concentric with the outer circumferential surface and having a smaller diameter. The inner circumferential surface of the outer fixing plate 125 may include a plurality of outer concave portions. The plurality of outer concave portions may be formed concavely from the inner circumferential surface of the outer fixing plate 125 toward the outer circumferential surface thereof. The plurality of outer concave portions may be formed to correspond to the plurality of outer convex portions 121, 122, 123, and 124 of the outer dome portion 126. The plurality of outer concave portions may be formed as a curve corresponding to the plurality of outer convex portions 121, 122, 123, and 124 of the outer dome portion 126, respectively.

The outer fixing plate 125 of the outer muffler 120 may be formed in a shape corresponding to the inner fixing plate 115 of the inner muffler 110.

The outer fixing plate 125 may be fixed to the flange part 925 of the lower flange 92. The outer fixing plate 125 may include the plurality of third bolt holes 128. The plurality of third bolt holes 128 may be formed to correspond to the plurality of second bolt holes 118 of the inner fixing plate 115 of the inner muffler 110. Some of the plurality of third bolt holes 128 may be formed between the plurality of outer convex portions 121, 122, 123, and 124. In this embodiment, three third bolt holes 128 may be formed between four outer convex portions 121, 122, 123, and 124.

The outer dome portion 126 may be formed by extending downward from the inner circumferential surface of the outer fixing plate 125. The outer dome portion 126 may be formed to protrude from the lower surface of the outer fixing plate 125 in a roughly dome shape. The plurality of outer convex portions 121, 122, 123, and 124 may be formed at regular intervals in the circumferential direction on the side surface of the outer dome portion 126. The plurality of outer convex portions 121, 122, 123, and 124 may be formed as curved surfaces that protrude toward the outside of the outer dome portion 126.

As illustrated in FIGS. 10 and 11, the plurality of outer convex portions 121, 122, 123, and 124 may protrude from the outer dome portion 126 toward the outer circumferential surface of the outer fixing plate 125. Therefore, the inner space of the outer dome portion 126 may be formed concavely and convexly. The inner space of the outer dome portion 126 may form the outer muffler space in which refrigerant is contained.

The plurality of outer convex portions 121, 122, 123, and 124 may be formed to be coupled with the plurality of inner convex portions 111, 112, and 113 of the inner muffler 110. For example, when the outer muffler 120 and the inner muffler 110 are coupled, the plurality of inner convex portions 111, 112, and 113 of the inner muffler 110 may be coupled with the plurality of outer convex portions 121, 122, 123, and 124 of the outer muffler 120. In detail, the inner convex portions 111, 112, and 113 of the inner muffler 110 may be inserted into the outer convex portions 121, 122, 123, and 124 of the outer muffler 120 so that the outer surfaces of the inner convex portions 111, 112, and 113 may contact or be adjacent to the inner surfaces of the outer convex portions 121, 122, 123, and 124.

The number of outer convex portions 121, 122, 123, and 124 of the outer muffler 120 may be formed at least one more than the number of inner convex portions 111, 112, and 113 of the inner muffler 110.

Therefore, the outer muffler 120 may include at least one non-coupled outer convex portion 124 that is not coupled with the plurality of inner convex portions 111, 112, and 113 of the inner muffler 110. In other words, at least one of the plurality of outer convex portions 121, 122, 123, and 124 of the outer muffler 120 may form the non-coupled outer convex portion 124 that is not coupled to the plurality of inner convex portions 111, 112, and 113 of the inner muffler 110.

The non-coupled outer convex portion 124 may form an outer muffler space S. The refrigerant may be accommodated in the outer muffler space S.

The refrigerant discharge passage 119 of the inner muffler 110 may be formed in the inner dome portion 116 of the inner muffler 110 facing the non-coupled outer convex portion 124 of the outer muffler 120. Therefore, the refrigerant discharged through the refrigerant discharge passage 119 of the inner muffler 110 may be accommodated within the non-coupled outer convex portion 124, i.e., in the outer muffler space S.

The non-coupled outer convex portion 124 may be formed to communicate with the sub-refrigerant hole 1101 of the inner muffler 110. In other words, the non-coupled outer convex portion 124 may be formed to cover the sub-refrigerant hole 1101 of the inner muffler 110.

Because the sub-refrigerant hole 1101 of the inner muffler 110 communicates with the refrigerant passage PF3 of the compression part 40 that is not in communication with the inner muffler space, the non-coupled outer convex portion 124 may communicate with the refrigerant passage PF3 that is not in communication with the inner muffler space. In other words, the non-coupled outer convex portion 124 may be formed to communicate with the refrigerant passage PF3 that is not in communication with the inner muffler space.

In this embodiment, the inner muffler 110 may include three inner convex portions 111, 112, and 113, and the outer muffler 120 may include four outer convex portions 121, 122, 123, and 124. In other words, the inner muffler 110 may include first, second, and third inner convex portions 111, 112, and 113, and the outer muffler 120 may include first, second, third, and fourth outer convex portions 121, 122, 123, and 124.

As illustrated in FIGS. 12 and 13, when the inner muffler 110 is coupled to the outer muffler 120, the inner fixing plate 115 of the inner muffler 110 may be in contact with the outer fixing plate 125 of the outer muffler 120, and the first, second, and third inner convex portions 111, 112, and 113 of the inner muffler 110 may be coupled to the first, second, and third outer convex portions 121, 122, and 123 of the outer muffler 120. At this time, the fourth outer convex portion 124 of the outer muffler 120 that is not coupled to the inner convex portions 111, 112, and 113 of the inner muffler 110, i.e., the non-coupled outer convex portion, may from the outer muffler space S.

The outer muffler space S may be defined by the volume of the inner muffler space and the rated volume of the rotary compressor 1. In other words, the sum of the volumes of the outer muffler space S and the inner muffler space may be the rated volume. The rated volume may refer to the volume capable of accommodating the amount of refrigerant corresponding to the rated load of the rotary compressor 1.

The fourth outer convex portion 124 of the outer muffler 120 may cover the sub-refrigerant hole 1101 of the inner muffler 110. In addition, the refrigerant discharge passage 119 of the inner muffler 110 may face the fourth outer convex portion 124. Therefore, the refrigerant discharge passage 119 and the sub-refrigerant hole 1101 of the inner muffler 110 may be in communication with the outer muffler space S of the outer muffler 120.

In other words, the outer muffler 120 may be configured so that the outer muffler space S communicates with the refrigerant passage that does not communicate with the inner muffler space and is far from the discharge hole 924 among the three refrigerant passages PF1, PF2, and PF3, i.e., the third refrigerant passage PF3.

In addition, when the inner muffler 110 and the outer muffler 120 are coupled, the plurality of second bolt holes 118 of the inner muffler 110 and the plurality of third bolt holes 128 of the outer muffler 120 may coincide with each other.

The refrigerant discharge passage 119 may be formed as a plurality of holes 1191, i.e., perforations, in a portion IA of the inner dome portion 116 of the inner muffler 110 that faces the fourth outer convex portion 124 of the outer muffler 120. The plurality of holes 1191 may be formed with a perforation ratio of 20% to 80%. In this case, the perforation ratio may be defined based on the area of the portion IA of the inner dome portion 116 that faces and contacts the fourth outer convex portion 124 of the outer muffler 120.

The outer muffler 120 may include at least one non-coupled outer convex portion 124. In this embodiment, because the inner muffler 110 includes one sub-refrigerant hole 1101, the outer muffler 120 may also include one non-coupled outer convex portion 124.

However, this disclosure is not limited thereto. The outer muffler 120 according to one or more embodiments of the disclosure may include two or more non-coupled outer convex portions 124.

A through hole 127 may be provided at the lower end of the outer dome portion 126. An oil pump disposed at the lower end of the drive shaft 30 may be immersed in oil contained in the oil reservoir 16 through the through hole 127 of the outer dome portion 126.

A caulking portion 129 may be provided at the lower end of the outer dome portion 126. The caulking portion 129 may be provided at the edge of the through hole 127. The caulking portion 129 may be formed so as to be fixed to one end of the boss 926 of the lower flange 92. When the caulking portion 129 of the outer dome portion 126 is joined to one end of the boss 926 of the lower flange 92, refrigerant may be prevented from leaking between one end of the boss 926 of the lower flange 92 and the through hole 127 of the outer dome portion 126.

The caulking portion 129 may be formed by caulking along the entire circumference of the through hole 127 of the outer dome portion 126.

The outer dome portion 126 may be provided between the outer fixing plate 125 and the caulking portion 129.

The upper end of the outer muffler 120 may be formed so as not to protrude above the lower surface of the lower flange 92. In detail, the outer fixing plate 125 of the outer muffler 120 may not protrude above the lower surface of the flange part 925 of the lower flange 92, but may be positioned below it. In other words, the upper surface of the outer fixing plate 125 of the outer muffler 120 may contact the lower surface of the inner fixing plate 115 of the inner muffler 110.

The upper surface of the outer fixing plate 125 of the outer muffler 120 may be formed so as not to contact the side surface of the flange part 925 of the lower flange 92. When the outer fixing plate 125 of the outer muffler 120 does not contact the side surface of the flange part 925 of the lower flange 92, pressure by the outer muffler 120 may not be applied to the bearing 927 disposed in the lower flange 92. In other words, the outer muffler 120 may be formed as a flat muffler.

The outer muffler 120, the inner muffler 110, and the lower flange 92 may be fixed to the upper cylinder 50 by a plurality of bolts 93. In detail, the plurality of bolts 93 may be fastened to the plurality of tapped holes 502 of the upper cylinder 50 through the plurality of third bolt holes 128 of the outer muffler 120, the plurality of second bolt holes 118 of the inner muffler 110, the plurality of first bolt holes 922 of the lower flange 92, the plurality of bolt holes 602 of the lower cylinder 60, and the plurality of bolt holes 702 of the intermediate plate 70. Then, the outer muffler 120, the inner muffler 110, the lower flange 92, the lower cylinder 60, and the intermediate plate 70 may be fixed to the upper cylinder 50 as a single body.

The noise of the refrigerant discharged downward through the discharge hole 924 of the lower flange 92 may be reduced as the refrigerant passes through the inner space of the lower muffler 100, and then the refrigerant may flow into the plurality of refrigerant holes 923 of the lower flange 92.

The refrigerant flowing into the plurality of refrigerant holes 923 of the lower flange 92 may be discharged to the upper side of the upper flange 91 through the plurality of refrigerant holes 603 of the lower cylinder 60, the plurality of refrigerant holes 703 of the intermediate plate 70, the plurality of refrigerant holes 503 of the upper cylinder 50, and the plurality of refrigerant holes 913 of the upper flange 91, i.e., the plurality of refrigerant passages PF1, PF2, and PF3.

The above description describes a case where the refrigerant discharge passage 119 of the inner muffler 110 is formed as a perforation, but the structure of the refrigerant discharge passage 119 may not be limited thereto. The refrigerant discharge passage 119 may be configured as a valve.

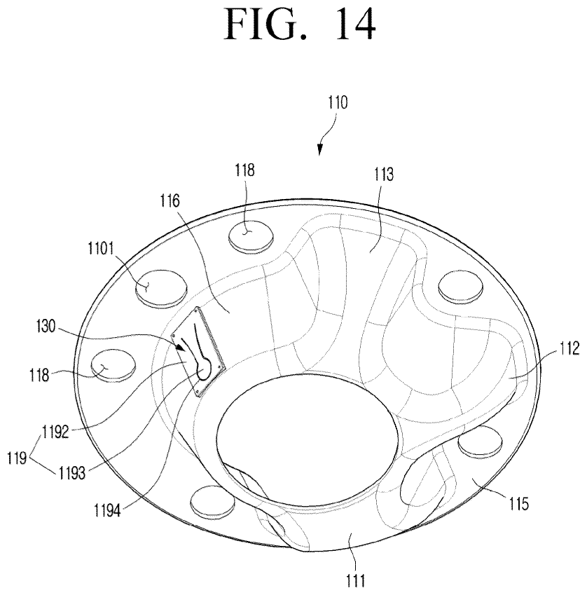

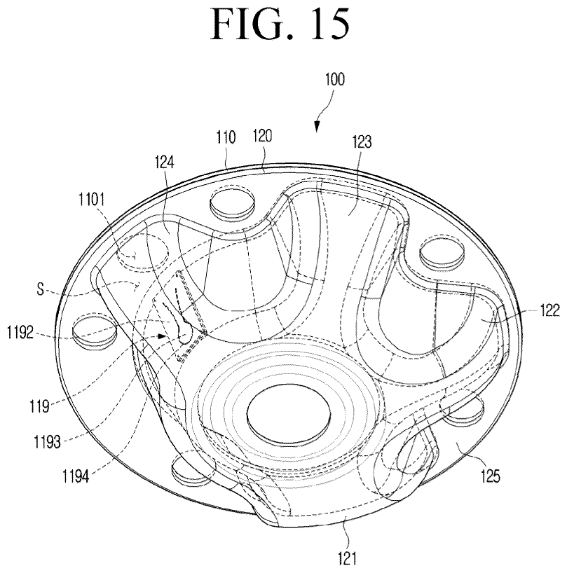

FIG. 14 is a perspective view illustrating an inner muffler 110 of a rotary compressor 1 according to one or more embodiments of the disclosure. FIG. 15 is a perspective view illustrating a state in which an inner muffler 110 and an outer muffler 120 of a rotary compressor 1 are coupled according to one or more embodiments of the disclosure.

Referring to FIG. 14, an inner muffler 110 according to one or more embodiments of the disclosure may include an inner fixing plate 115 and an inner dome portion 116.

The inner fixing plate 115 and the inner dome portion 116 of the inner muffler 110 illustrated in FIG. 14 may be identical in all structures to the inner muffler 110 illustrated in FIGS. 8 and 9 except for the refrigerant discharge passage 119, and therefore, a detailed description thereof is omitted.

Referring to FIG. 14, the inner muffler 110 may include a refrigerant discharge passage 119. The refrigerant discharge passage 119 may be formed as a plate valve. The plate valve may be disposed in a portion of the inner dome portion 116 where the plurality of inner convex portions 111, 112, and 113 are not formed. The refrigerant accommodated in the inner muffler space of the inner muffler 110 may selectively pass through the plate valve depending on the pressure of the refrigerant and move to the outer muffler space S of the outer muffler 120.

The plate valve may include a base 1192 and a leaf 1193. The base 1192 may be provided with an opening 1194 corresponding to the leaf 1193. The opening 1194 may communicate with the inner space of the inner muffler 110. One end of the leaf 1193 may be fixed to the base 1192. The leaf 1193 may be formed of an elastic material. Therefore, the leaf 1193 may open and close the opening 1194 of the base 1192 depending on the internal pressure of the inner muffler 110.

When the amount of refrigerant contained in the inner muffler space of the inner muffler 110 increases and the stagnant pressure of the refrigerant rises above a certain level, one end of the leaf 1193 may rise, opening the opening 1194 of the base 1192. Then, the refrigerant of the inner muffler 110 may move to the outer muffler space S of the outer muffler 120 through the plate valve.

When the stagnant pressure in the inner muffler space of the inner muffler 110 decreases, the leaf 1193 may descend, blocking the opening 1194 of the base 1192. Therefore, the refrigerant in the inner muffler space may not flow to the outer muffler space S through the refrigerant discharge passage 119, i.e., the plate valve.

The inner muffler 110 may be coupled to the outer muffler 120. The outer muffler 120 may be identical to the outer muffler 120 illustrated in FIGS. 10 and 11, and therefore, a detailed description thereof is omitted.

As illustrated in FIG. 15, when the inner muffler 110 is coupled to the outer muffler 120, the inner fixing plate 115 of the inner muffler 110 may come into contact the outer fixing plate 125 of the outer muffler 120, and the first, second, and third inner convex portions 111, 112, and 113 of the inner muffler 110 may be coupled to the first, second, and third outer convex portions 121, 122, and 123 of the outer muffler 120. At this time, the fourth outer convex portion 124 of the outer muffler 120 that is not coupled to the inner convex portions 111, 112, and 113 of the inner muffler 110, i.e., the non-coupled outer convex portion may form the outer muffler space S.

The fourth outer convex portion 124 of the outer muffler 120 may cover the sub-refrigerant hole 1101 of the inner muffler 110. In addition, the refrigerant discharge passage 119 of the inner muffler 110 may face the fourth outer convex portion 124. Therefore, the refrigerant discharge passage 119 and the sub-refrigerant hole 1101 of the inner muffler 110 may be in communication with the outer muffler space S of the outer muffler 120.

When the amount of refrigerant contained in the inner muffler space of the inner muffler 110 increases and the stagnant pressure of the refrigerant rises above a certain level, one end of the leaf 1193 may rise, opening the opening 1194 of the base 1192. Then, the refrigerant in the inner muffler 110 may move to the outer muffler space S of the outer muffler 120 through the plate valve and flow into the refrigerant passage PF3 of the compression part 40 through the sub-refrigerant hole 1101.

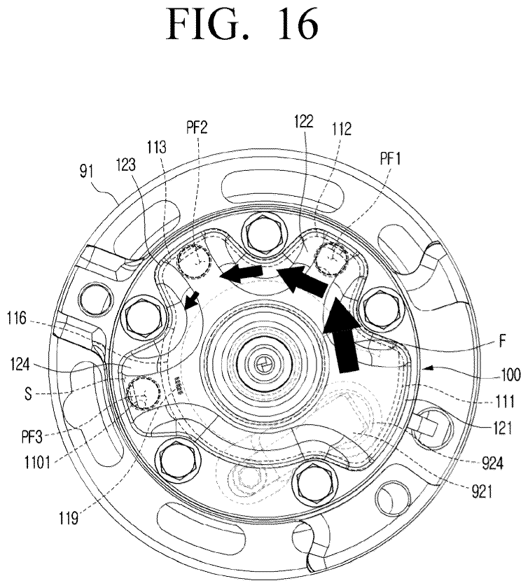

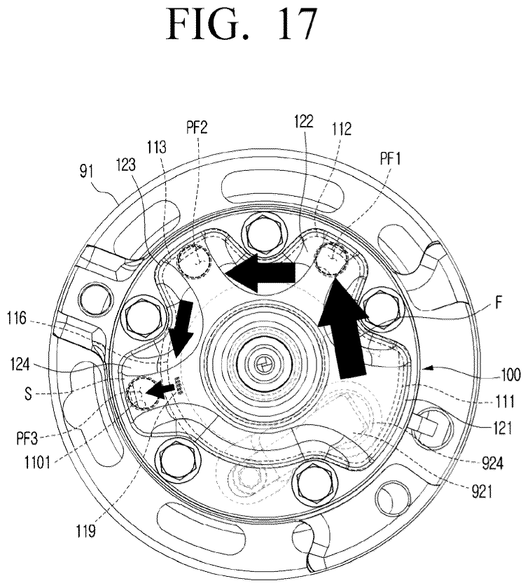

Hereinafter, the operation of a rotary compressor 1 according to one or more embodiments of the disclosure will be described in detail with reference to FIGS. 16 and 17.

The rotary compressor 1 according to one or more embodiments of the disclosure may operate under various load conditions. For example, the rotary compressor 1 may operate under low, medium, and high load conditions. The high load condition may be the rated load of the rotary compressor 1. The load condition may vary depending on the operating conditions of the rotary compressor 1.

When the rotary compressor 1 operates under a certain load, refrigerant may be discharged from the lower surface of the compression part 40, i.e., from the discharge hole 924 of the lower flange 92.

When the load applied to the rotary compressor 1 increases, the flow rate of the refrigerant discharged from the compression part 40 may increase. In other words, the flow rate of the refrigerant discharged from the compression part 40 when the rotary compressor 1 operates at low load may be less than the flow rate of the refrigerant discharged from the compression part 40 when the rotary compressor 1 operates at medium load and high load.

The flow rate of the refrigerant discharged from the compression part 40 when the rotary compressor 1 operates at medium load may be greater than the flow rate of the refrigerant discharged from the compression part 40 when the rotary compressor 1 operates at low load, and may be less than the flow rate of the refrigerant discharged from the compression part 40 when the rotary compressor 1 operates at high load. The flow rate of the refrigerant discharged from the compression part 40 when the rotary compressor 1 operates at high load may be greater than the flow rate of the refrigerant discharged from the compression part 40 when the rotary compressor 1 operates at low load and medium load.

FIG. 16 is a view illustrating a flow of refrigerant when a rotary compressor 1 operates at low load according to one or more embodiments of the disclosure.

As illustrated in FIG. 16, when the rotary compressor 1 operates at low load, a small amount of refrigerant F may be discharged from the discharge hole 924. The refrigerant discharged from the discharge hole 924 may move along the space of the inner muffler 110, i.e., the inner muffler space.

In this embodiment, as illustrated in FIG. 16, the discharge hole 924 is located at the lower part of the first inner convex portion 111 of the inner muffler 110. Therefore, the refrigerant discharged from the discharge hole 924 may move to the upper part of the first inner convex portion 111. The refrigerant that has moved to the upper part of the first inner convex portion 111 may flow into the second inner convex portion 112. Because the inner space of the second inner convex portion 112 is in communication with the first refrigerant passage PF1, some of the refrigerant, i.e., a first amount of refrigerant, may flow into the first refrigerant passage PF1, move along the first refrigerant passage PF1, and flow into the upper side of the upper flange 91, i.e., the inner space of the upper muffler 80.

The remaining refrigerant may continue to move and flow into the third inner convex portion 113. Because the inner space of the third inner convex portion 113 is in communication with the second refrigerant passage PF2, most of the remaining refrigerant, i.e., a second amount of refrigerant, may flow into the second refrigerant passage PF2, move along the second refrigerant passage PF2, and flow into the inner space of the upper muffler 80. A very small amount of the remaining refrigerant, i.e., a third amount of refrigerant, may continue to move along the inner dome portion 116 of the inner muffler 110. However, because the third amount of refrigerant moving along the inner dome portion 116 is very small, the stagnant pressure is very low, preventing the refrigerant from passing through the refrigerant discharge passage 119.

FIG. 17 is a view illustrating a flow of refrigerant when a rotary compressor 1 operates at high load according to one or more embodiments of the disclosure.

As illustrated in FIG. 17, when the rotary compressor 1 operates at high load, a large amount of refrigerant, i.e., refrigerant of the rated capacity, may be discharged from the discharge hole 924. The refrigerant discharged from the discharge hole 924 may move along the space of the inner muffler 110, i.e., the inner muffler space.

In this embodiment, as illustrated in FIG. 17, the discharge hole 924 is located at the lower part of the first inner convex portion 111 of the inner muffler 110, so the refrigerant F coming out of the discharge hole 924 may move to the upper part of the first inner convex portion 111. The refrigerant that has moved to the upper part of the first inner convex portion 111 may flow into the second inner convex portion 112. Because the inner space of the second inner convex portion 112 is in communication with the first refrigerant passage PF1, some of the refrigerant, i.e., a first amount of refrigerant, may flow into the first refrigerant passage PF1, move along the first refrigerant passage PF1, and flow into the upper side of the upper flange 91, i.e., the inner space of the upper muffler 80.

The remaining refrigerant may continue to move and flow into the third inner convex portion 113. Because the inner space of the third inner convex portion 113 is in communication with the second refrigerant passage PF2, some of the remaining refrigerant, i.e., a second amount of refrigerant, may flow into the second refrigerant passage PF2, move along the second refrigerant passage PF2, and flow into the inner space of the upper muffler 80.

The remainder of the remaining refrigerant, i.e., a third amount of refrigerant, may continue to move along the inner dome portion 116 of the inner muffler 110. Because the third amount of refrigerant moving along the inner dome portion 116 is large in quantity, the stagnant pressure is high, so that the refrigerant may pass through the refrigerant discharge passage 119. Therefore, the third amount of refrigerant may pass through the refrigerant discharge passage 119 and flow into the inner space of the fourth outer convex portion 124, i.e., the non-coupled outer convex portion, of the outer muffler 120, i.e., the outer muffler space S. Because the outer muffler space S is in communication with the third refrigerant passage PF3 through the sub-refrigerant hole 1101 of the inner muffler 110, the third amount of refrigerant may move along the third refrigerant passage PF3 and flow into the inner space of the upper muffler 80.

When the rotary compressor 1 operates at medium load, some refrigerant may pass through the refrigerant discharge passage 119 of the inner muffler 110 and move to the upper muffler 80 via the third refrigerant passage PF3. In this case, the amount of refrigerant moving to the upper muffler 80 via the third refrigerant passage PF3 may be less than when the rotary compressor 1 operates at high load.

The refrigerant discharged into the inner space of the upper muffler 80 may be discharged through the plurality of openings 81 of the upper muffler 80 to the upper side of the upper muffler 80, i.e., the space between the motor 20 and the compression part 40.

The refrigerant that has moved into the space between the motor 20 and the compression part 40 may move to the upper side of the motor 20 through the motor 20. For example, the refrigerant in the space between the motor 20 and the compression part 40 may move to the upper side of the motor 20 through the gap between the rotor 22 and the stator 21 and the plurality of refrigerant holes 27 provided in the rotor 22.

The refrigerant moving to the upper side of the motor 20 may be discharged to the outside of the casing 10 through the refrigerant discharge pipe 14 disposed in the upper casing 11.

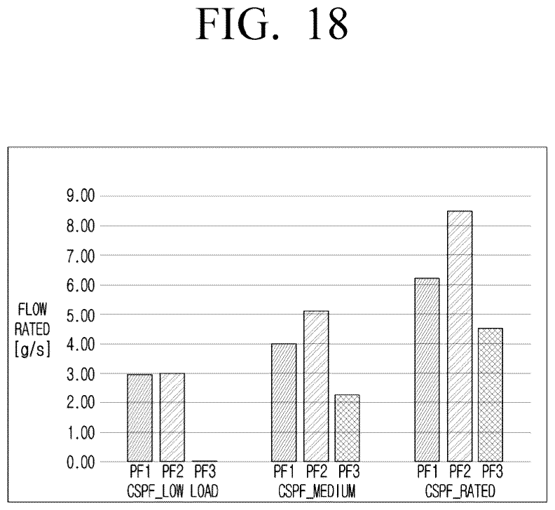

Hereinafter, with reference to FIG. 18, when the rotary compressor 1 according to one or more embodiments of the disclosure operates, the flow rates of refrigerant passing through the plurality of refrigerant passages will be compared and explained according to the load applied to the rotary compressor 1.

FIG. 18 is a graph illustrating a flow rate of refrigerant passing through a plurality of refrigerant passages according to operating conditions of a rotary compressor 1 according to one or more embodiments of the disclosure.

For reference, in FIG. 18, the vertical axis represents the flow rate of refrigerant passing through the plurality of refrigerant passages PF1, PF2, and PF3. The horizontal axis represents the plurality of refrigerant passages when the rotary compressor 1 operates at low, medium, and rated loads. The load is based on the cooling seasonal performance factor (CSPF). Accordingly, CSPF_low load refers to low temperature in CSPF, CSPF_medium refers to medium temperature in CSPF, and CSPF_rated refers to high temperature in CSPF.

Referring to FIG. 18, when the rotary compressor 1 operates at low load (CSPF_low load), refrigerant may move to the upper side of the compression part 40 through the first refrigerant passage PF1 and the second refrigerant passage PF2. Because the amount of refrigerant discharged from the discharge hole 924 is small, no refrigerant is discharged into the outer muffler space S of the outer muffler 120 through the refrigerant discharge passage 119 of the inner muffler 110. In this case, the flow rates of refrigerant passing through the first refrigerant passage PF1 and the second refrigerant passage PF2 may be approximately equal.

When the rotary compressor 1 operates at medium load (CSPF_medium), refrigerant may move to the upper side of the compression part 40 through the first refrigerant passage PF1, the second refrigerant passage PF2, and the third refrigerant passage PF3. In other words, the refrigerant discharged from the discharge hole 924 may flow into the first refrigerant passage PF1 and the second refrigerant passage PF2 through the inner muffler space of the inner muffler 110. In addition, because the amount of refrigerant discharged from the discharge hole 924 is large, some of the refrigerant may be discharged into the outer muffler space S of the outer muffler 120 through the refrigerant discharge passage 119 of the inner muffler 110. The refrigerant introduced into the outer muffler space S may be introduced into the third refrigerant passage PF3. In this case, the flow rate of the refrigerant passing through the first refrigerant passage PF1 may be less than the flow rate of the refrigerant passing through the second refrigerant passage PF2 and greater than the flow rate of the refrigerant passing through the third refrigerant passage PF3. In other words, the flow rate of the refrigerant passing through the second refrigerant passage PF2 may be the largest, and the flow rate of the refrigerant passing through the third refrigerant passage PF3 may be the smallest.

When the rotary compressor 1 operates at high load (CSPF_rated), refrigerant may move to the upper side of the compression part 40 through the first refrigerant passage PF1, the second refrigerant passage PF2, and the third refrigerant passage PF3. In other words, the refrigerant discharged from the discharge hole 924 may flow into the first refrigerant passage PF1 and the second refrigerant passage PF2 through the inner muffler space of the inner muffler 110. In addition, because the amount of refrigerant discharged from the discharge hole 924 is very large, some of the refrigerant may be discharged into the outer muffler space S of the outer muffler 120 through the refrigerant discharge passage 119 of the inner muffler 110. The refrigerant introduced into the outer muffler space S may flow into the third refrigerant passage PF3. In this case, the flow rate of the refrigerant passing through the first refrigerant passage PF1 may be less than the flow rate of the refrigerant passing through the second refrigerant passage PF2 and greater than the flow rate of the refrigerant passing through the third refrigerant passage PF3. In other words, the flow rate of the refrigerant passing through the second refrigerant passage PF2 may be the largest, and the flow rate of the refrigerant passing through the third refrigerant passage PF3 may be the smallest.

As described above, the rotary compressor 1 according to one or more embodiments of the disclosure may change the volume of the inner space of the lower muffler 100 according to the refrigerant flow rate that changes depending on the operating conditions, and thus may respond to a wide range of operating conditions.

In the case of a rotary compressor 1 in which the volume of the inner space of the lower muffler 100 is defined to correspond to the rated load, when the rotary compressor 1 operates at low load, the volume of the inner space of the lower muffler 100 is too large compared to the amount of circulating refrigerant, thereby reducing the efficiency of the rotary compressor 1.

However, in the rotary compressor 1 according to one or more embodiments of the disclosure, when operating at low load, the refrigerant may circulate only through the inner space of the inner muffler 110. When operating at high load, the refrigerant may circulate through the inner space of the inner muffler 110 and the inner space of the outer muffler 120. Therefore, when the rotary compressor 1 operates at low load, the efficiency of the rotary compressor 1 may not be reduced.

In addition, in the rotary compressor 1 according to one or more embodiments of the disclosure, because the refrigerant discharge passage 119, which connects the inner muffler 110 and the outer muffler 120, is configured to be selectively operated based on the refrigerant flow rate, a separate electrical device for operating the refrigerant discharge passage 119 is not required. Therefore, the material cost of the rotary compressor 1 may be minimized.

In addition, because the rotary compressor 1 according to one or more embodiments of the disclosure has a lower muffler 100 having a double structure of an inner muffler 110 and an outer muffler 120, leakage of refrigerant between the lower muffler 100 and the lower flange 92 due to deformation of the lower muffler 100 when the rotary compressor 1 operates at high load may be prevented or minimized.

In the foregoing, the disclosure has been shown and described with reference to various embodiments. However, it is understood by those skilled in the art that various changes may be made in form and detail without departing from the scope of the disclosure as defined by the appended claims and equivalents thereof.

1. A rotary compressor comprising:
a casing;
a motor to be disposed inside the casing;
a compression part to be disposed below the motor;
a plurality of refrigerant passages configured to penetrate the compression part along an edge of the compression part;
an upper muffler, to be disposed on an upper surface of the compression part, forming an upper muffler space that allows refrigerant to be introduced thereto along a vertical direction of the rotary compressor through the plurality of refrigerant passages;
an inner muffler, to be disposed on a lower surface of the compression part, forming an inner muffler space that prevents refrigerant from passing through at least one refrigerant passage among the plurality of refrigerant passages and allows the refrigerant to pass through remaining refrigerant passages among the plurality of refrigerant passages;
an outer muffler, to be disposed below the inner muffler, forming an outer muffler space, the outer muffler being in contact with a portion of the inner muffler and allowing the refrigerant from the inner muffler space prevented from passing through the at least one refrigerant passage to pass through; and
a refrigerant discharge passage, to be provided on the portion of the inner muffler in contact with the outer muffler space, configured such that the refrigerant in the inner muffler space is selectively discharged to the outer muffler space depending on a flow rate of refrigerant discharged from the lower surface of the compression part.

2. The rotary compressor of claim 1, wherein
the refrigerant discharge passage is formed as a plurality of holes.

3. The rotary compressor of claim 2, wherein
the plurality of holes are formed with a perforation ratio of 20% to 80%.

4. The rotary compressor of claim 1, wherein
the refrigerant discharge passage is configured as a plate valve.

5. The rotary compressor of claim 1, wherein
the lower surface of the compression part includes a discharge hole through which compressed refrigerant is discharged, and
the discharge hole is located in the inner muffler space.

6. The rotary compressor of claim 5, wherein
the plurality of refrigerant passages include three refrigerant passages, and
the inner muffler is configured such that the refrigerant from the inner muffler space passes through two refrigerant passages adjacent to the discharge hole along a direction of flow of the refrigerant discharged from the discharge hole among the three refrigerant passages, and the refrigerant is prevented from passing through a refrigerant passage far from the discharge hole along the direction of flow of the refrigerant.

7. The rotary compressor of claim 6, wherein
the outer muffler is configured such that the refrigerant from the outer muffler space passes through to the refrigerant passage, among the three refrigerant passages, which is far from the discharge hole, and is prevented from passing through the inner muffler space.

8. The rotary compressor of claim 1, wherein
the inner muffler is formed in a dome shape and includes a plurality of inner convex portions formed at regular intervals along a circumferential direction of the inner muffler on a side surface of the inner muffler, and
the plurality of refrigerant passages through which the refrigerant is introduced to the inner muffler space are located in the plurality of inner convex portions.

9. The rotary compressor of claim 8,
the outer muffler formed in a dome shape corresponding to the inner muffler and includes a plurality of outer convex portions formed at regular intervals along a circumferential direction of the outer muffler on a side surface of the outer muffler, and
a number of the plurality of outer convex portions is at least one more than a number of the plurality of inner convex portions.

10. The rotary compressor of claim 9, wherein
based on the outer muffler and the inner muffler being coupled, all of the plurality of inner convex portions of the inner muffler are coupled to the plurality of outer convex portions of the outer muffler, and an non-coupled outer convex portion of the outer muffler that is not coupled to the plurality of inner convex portions of the inner muffler forms the outer muffler space.

11. The rotary compressor of claim 10, wherein
the refrigerant discharge passage is formed on a side surface of the inner muffler facing the non-coupled outer convex portion of the outer muffler.

12. The rotary compressor of claim 10, wherein
the at least one refrigerant passage is located in the non-coupled outer convex portion of the outer muffler that is not coupled with the plurality of inner convex portions of the inner muffler.

13. The rotary compressor of claim 12, wherein
the inner muffler further comprises a sub-refrigerant hole formed at a position corresponding to the non-coupled outer convex portion of the outer muffler.

14. The rotary compressor of claim 10, wherein
the inner muffler includes first, second, and third inner convex portions,
the outer muffler includes first, second, third, and fourth outer convex portions, and
based on the inner muffler and the outer muffler being coupled, the first, second, and third inner convex portions are coupled to the first, second, third, and fourth outer convex portions to form the outer muffler space.

15. The rotary compressor of claim 1, wherein
a sum of a volume of the inner muffler space and a volume of the outer muffler space is a rated volume.
